(19) United States
(12) Patent Application Publication
(10) Pub. No.: US 2015/0239103 A1
(43) Pub. Date: Aug. 27, 2015

(54) WRENCH

(71) Applicant: Milwaukee Electric Tool Corporation, Brookfield, WI (US)

(72) Inventors: Tauhira Hoossainy, Milwaukee, WI (US); Kyle Harvey, Wauwatosa, WI (US); Timothy Janda, Elkhorn, WI (US); Steven W. Hyma, Milwaukee, WI (US)

(21) Appl. No.: 14/626,967

(22) Filed: Feb. 20, 2015

Related U.S. Application Data
(60) Provisional application No. 61/944,806, filed on Feb. 26, 2014.

(51) Int. Cl. B25B 13/14

(52) U.S. Cl. CPC B25B 13/14

(57) ABSTRACT

A wrench is configured to rotate a fastener and including a handle, and a head coupled to the handle. The head includes a first jaw configured to engage the fastener and a second jaw configured to engage the fastener. The second jaw includes a rack gear and the second jaw is movable with respect to the first jaw to adjust a distance between the first jaw and the second jaw. The wrench also includes an adjustment mechanism operable to move the second jaw with respect to the first jaw. The adjustment mechanism includes a worm gear that engages the rack gear. The rack gear includes a plurality of teeth defining a rectangular profile between each of the plurality of teeth.

### CROSS-REFERENCE TO RELATED APPLICATIONS

This application claims priority to U.S. Provisional Patent Application No. 61/944,806, filed Feb. 26, 2014, the entire contents of which are incorporated by reference herein.

### BACKGROUND

The present invention relates to wrenches, and more particularly to adjustable wrenches.

Some types of conventional, adjustable wrenches include a fixed jaw and a movable jaw coupled to the fixed jaw by an adjustment mechanism. The adjustment mechanism of such an adjustable wrench can be manipulated to adjust the spacing between the fixed jaw and the movable jaw, allowing the wrench to accommodate a variety of differently sized fasteners. With many conventional wrenches, however, play or slop in the adjustment mechanism can alter the set spacing between the fixed jaw and the movable jaw. This necessitates time-consuming readjustment if a user desires to turn multiple fasteners of the same size.

### SUMMARY

In one embodiment, the invention provides a wrench is configured to rotate a fastener and including a handle, and a head coupled to the handle. The head includes a first jaw configured to engage the fastener and a second jaw configured to engage the fastener. The second jaw includes a rack gear and the second jaw is movable with respect to the first jaw to adjust a distance between the first jaw and the second jaw. The wrench also includes an adjustment mechanism operable to move the second jaw with respect to the first jaw. The adjustment mechanism includes a worm gear that engages the rack gear. The rack gear includes a plurality of teeth defining a rectangular profile between each of the plurality of teeth.

In another embodiment, the invention provides a wrench configured to rotate a fastener and including a handle, and a head coupled to the handle. The head includes a first jaw configured to engage the fastener and a second jaw configured to engage the fastener. The second jaw includes a rack gear and the second jaw is movable with respect to the first jaw to adjust a distance between the first jaw and the second jaw. The wrench also includes an adjustment mechanism operable to move the second jaw with respect to the first jaw. The adjustment mechanism includes a worm gear that engages the rack gear. The rack gear includes a plurality of teeth. Each of the plurality of teeth includes a first side surface, a second side surface, and a top surface that extends from the first side surface to the second side surface. The first side surface is orientated relative to the top surface at a first angle. The second side surface is orientated relative to the top surface at a second angle. The first and the second angles are substantially 90 degrees.

Other aspects of the invention will become apparent by consideration of the detailed description and accompanying drawings.

### BRIEF DESCRIPTION OF THE DRAWINGS

FIG. 1 is a perspective view of a wrench according to an embodiment of the invention.

FIG. 2 is an exploded view of an adjustment mechanism of the wrench of FIG. 1.

FIG. 3 is a cross sectional view taken along line 3-3 of FIG. 1.

FIG. 4 is a detailed view of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

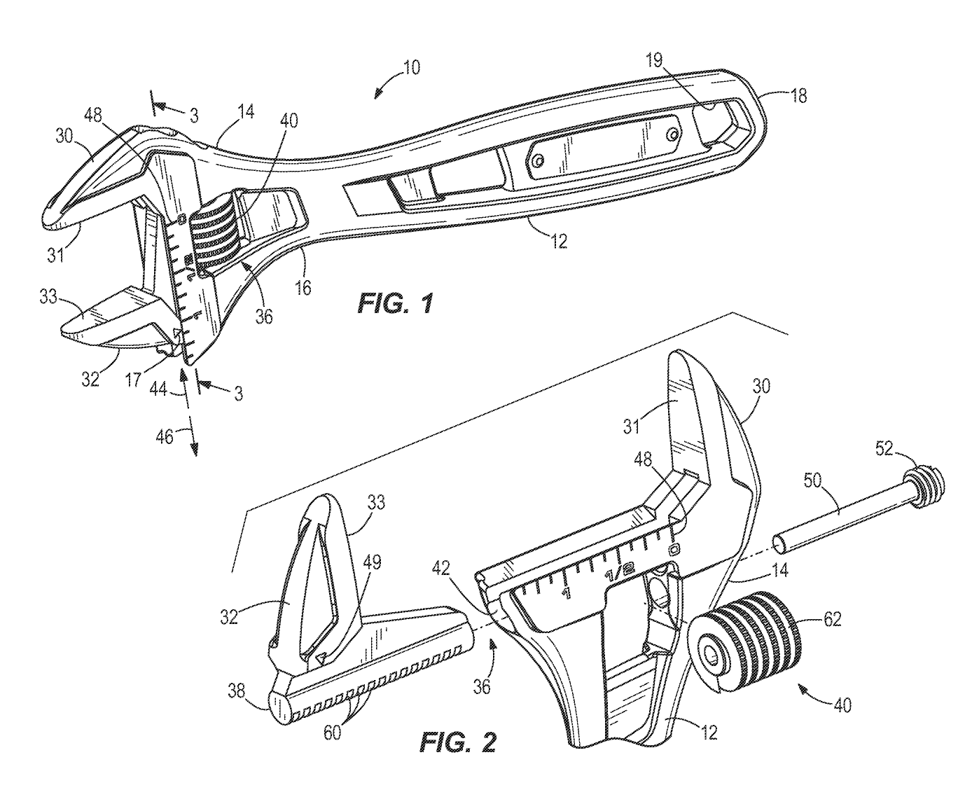

FIG. 1 illustrates a wrench 10. The wrench 10 includes a handle 12 and a head 14. The handle 12 is elongated and has a front end portion 16 and a rear end portion 18. The handle includes an aperture 19 extending through the handle 12 at the rear end portion 18. The aperture 19 provides a location for hanging the wrench 10 (e.g., for storage purposes). In some embodiments, the aperture 19 can be shaped as a drive, such as a multi-point drive, a hex-drive, or a square drive.

With reference to FIG. 2, the head 14 includes a first or fixed jaw 30 having a generally planar contact surface 31 and a second or movable jaw 32 having a generally planar contact surface 33. In the illustrated embodiment, the contact surface 31 extends generally parallel to the contact surface 33. The head 14 further includes an adjustment mechanism 36, which is a worm drive 36 in the illustrated embodiment. The worm drive 36 includes a rack gear 38 and a worm gear 40.

The illustrated worm gear 40 includes a single thread 62. The illustrated thread 62 is a square thread (FIG. 4). In other words, the thread 62 includes a first side surface 72, a second side surface 76, and a top surface 80. The top surface 80 extends from the first side surface 72 to the second side surface 76. The first side surface 72 is orientated relative to the top surface 80 at a first angle θ₁. Likewise, the second side surface 76 is orientated relative to the top surface 80 at a second angle θ₂. The illustrated first and second angles θ_{1,2} are 90 degrees. In other embodiments, the first and the second angles θ_{1,2} may vary from 88 to 92 degrees. The illustrated angles θ_{1,2} are equal; however, in other embodiments the angles θ_{1,2} may not be equal. The illustrated thread 62 includes a pitch of about 3.5 millimeters. In other embodiments, the thread 62 may include a pitch of about 2.5 millimeters. In other embodiments, the worm gear 40 may define a double-lead worm gear including two threads. The worm gear 40 is rotatably coupled to the head 14 via a pin 50 and the worm gear 40 rotates about the pin 50 and meshes with the rack gear 38 to move the jaw 32 in the direction of arrows 44 and 46 (FIG. 1) relative to the fixed jaw 30. The pin 50 includes a threaded portion 52. The threaded portion 52 couples the pin 50 to the head 14. In some embodiments, the pin 50 may be held from rotation with respect to the head 14 by a set screw (not shown).

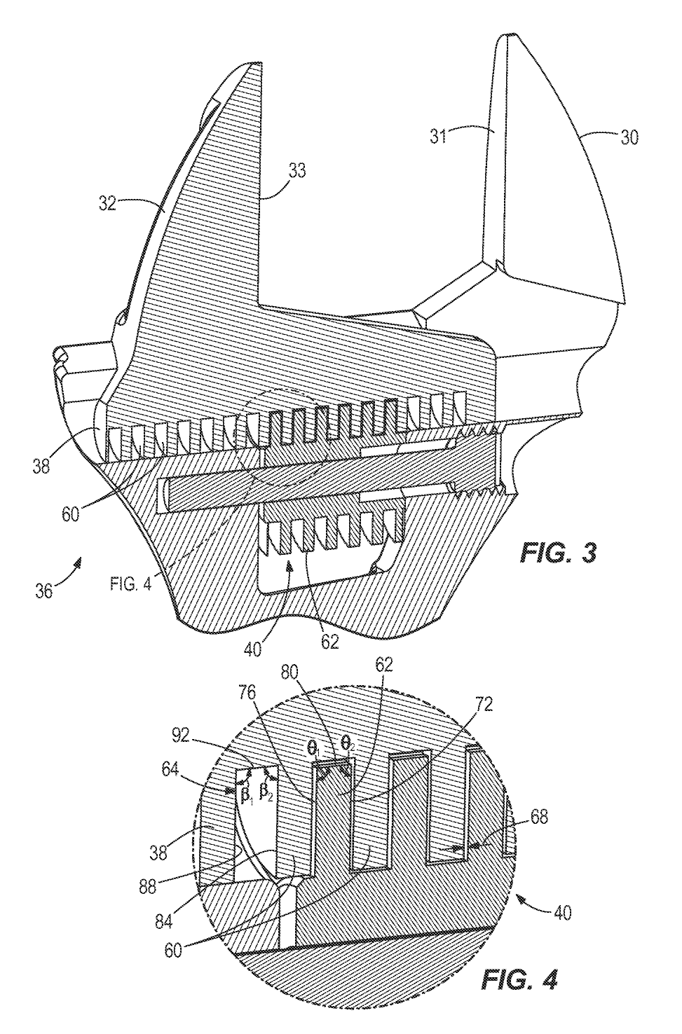

With reference to FIGS. 3 and 4, the rack gear 38 includes a plurality of teeth 60 and is fixed to the movable jaw 32 for movement with the movable jaw 32 relative to the fixed jaw 30. Regions between each of the plurality of teeth 60 are defined by a rectangular profile 64. In other words, the rectangular profile 64 includes a first side surface 84, a second side surface 88, and a top surface 92. The top surface 92 extends from first side surface 84 to the second side surface 88. The first side surface 84 is orientated relative to the top surface 92 at a first angle β₁. Likewise, the second side surface 88 is orientated relative to the top surface 92 at a second angle 132. The illustrated first and second angles β_{1,2} are 90 degrees. In other embodiments, the first and the second angles β_{1,2} may vary from 88 to 92 degrees. The illustrated angles β_{1,2} are equal; however, in other embodiments, the angles β_{1,2} may not be equal.

The rack gear 38 is received in a generally cylindrical aperture 42 of the head 14 (FIG. 2). The aperture 42 guides the generally cylindrical rack gear 38 to guide movement of the jaw 32 so that the jaw 32 moves parallel to the arrows 44 and 46 in FIG. 1. In the illustrated embodiment, the fixed jaw 30 includes indicia 48 in the form of a measurement scale. The movable jaw 32 includes an indicator 49 that aligns with the indicia 48 to provide an indication of the spacing between the contact surfaces 31, 33. Accordingly, the jaws 30, 32 may be quickly and accurately adjusted to accommodate differently sized fasteners, without requiring trial and error.

The worm drive 36 is dependent upon the engagement between the rack gear 38 and the worm gear 40 to move the moveable jaw 32 in the direction of the arrows 44 and 46. As a result, it is advantageous to optimize the amount of mechanical backlash 68 (FIG. 4) between the rack gear 38 and the worm gear 40. In particular, mechanical backlash 68 is the clearance (e.g., distance) between the thread 62 and the teeth 60 that creates a degree of play or loss of motion before the thread 62 engages the teeth 60. For example, if there is not enough mechanical backlash, the thread 62 and the teeth 60 will seize and operation of the worm drive 36 will be compromised. In contrast, if there is too much mechanical backlash, there will an undesirable amount of play or loss of motion between the thread 62 and the teeth 60. The square thread construction of the thread 62 engaging the rectangular profile 64 provides an optimum amount of mechanical backlash 68 yielding smooth operation of the wrench 10.

In operation, the user can use the wrench 10 to turn a fastener (not shown), such as a hex head nut, a bolt, and the like. The user first rotates the worm gear 40 to adjust the spacing between the jaws 30 and 32 (i.e., the perpendicular distance between contact surfaces 31 and 33 of the jaws 30 and 32). As the user rotates the worm gear 40, the meshing between the worm gear 40 and the rack gear 38 causes the movable jaw 32 to move in the direction of either arrow 44 or 46 (FIG. 1), depending on which direction the worm gear 40 is rotated. The user adjusts the spacing so that the spacing is slightly larger than a distance between opposite sides of the fastener. The user may adjust the spacing by relying upon the indicator 49 and the indicia 48. Alternatively, the user may adjust the spacing with the fastener already inserted between the contact surface 31 and 33 by rotating the worm gear 40 until the contact surfaces 31 and 33 contact the fastener. Once the spacing is properly set, the user may rotate the wrench 10 to turn the fastener.

Although the invention has been described in detail with reference to certain preferred embodiments, variations and modifications exist within the scope and spirit of one or more independent aspects of the invention as described.

1. A wrench configured to rotate a fastener, the wrench comprising:
a handle;
a head coupled to the handle, the head including a first jaw configured to engage the fastener and a second jaw configured to engage the fastener, the second jaw including a rack gear and the second jaw movable with respect to the first jaw to adjust a distance between the first jaw and the second jaw; and
an adjustment mechanism operable to move the second jaw with respect to the first jaw, the adjustment mechanism including a worm gear that engages the rack gear, the rack gear including a plurality of teeth defining a rectangular profile between each of the plurality of teeth.

2. The wrench of claim 1, wherein the rectangular profile includes a first side surface, a second side surface, and a top surface that extends from the first side surface to the second side surface, and wherein the first side surface is orientated at a first angle relative to the top surface, and wherein the second side surface is orientated at a second angle relative to the top surface.

3. The wrench of claim 2, wherein the first and the second angles are between 88 and 92 degrees.

4. The wrench of claim 1, wherein the worm gear includes a square thread.

5. The wrench of claim 4, wherein the square thread includes a pitch of about 3.5 millimeters.

6. The wrench of claim 4, wherein the square thread includes a pitch of about 2.5 millimeters.

7. The wrench of claim 1, wherein the worm gear is a double lead worm gear.

8. The wrench of claim 1, wherein the head includes a generally cylindrical aperture and wherein the rack gear is at least partially received within the cylindrical aperture and the rack gear slides within the cylindrical aperture to adjust the distance between the first jaw and the second jaw.

9. The wrench of claim 1, wherein the handle is an elongated handle having a front end portion and a rear end portion, wherein the head is coupled to the handle at the front end portion, and wherein an aperture extends through the handle at the rear end portion of the handle.

10. A wrench configured to rotate a fastener, the wrench comprising:
a handle;
a head coupled to the handle, the head including a first jaw configured to engage the fastener and a second jaw configured to engage the fastener, the second jaw including a rack gear and the second jaw movable with respect to the first jaw to adjust a distance between the first jaw and the second jaw; and
an adjustment mechanism operable to move the second jaw with respect to the first jaw, the adjustment mechanism including a worm gear that engages the rack gear, the rack gear including a plurality of teeth, each of the plurality of teeth including a first side surface, a second side surface, and a top surface that extends from the first side surface to the second side surface, the first side surface is orientated relative to the top surface at a first angle, the second side surface is orientated relative to the top surface at a second angle,
wherein the first and the second angles are substantially 90 degrees.

11. The wrench of claim 10, wherein the first and the second angles are between 88 and 92 degrees.

12. The wrench of claim 10, wherein the worm gear includes a square thread.

13. The wrench of claim 12, wherein the square thread includes a first side surface, a second side surface, and a top surface that extends from the first side surface to the second side surface, and wherein the first side surface of the square thread is orientated at a first angle relative to the top surface of the square thread, and wherein the second side surface of the square thread is orientated at a second angle relative to the top surface of the square thread.

14. The wrench of claim 13, wherein the first and the second angles of the square thread are between 88 and 92 degrees.

15. The wrench of claim 12, wherein the square thread includes a pitch of about 3.5 millimeters.

16. The wrench of claim 12, wherein the square thread includes a pitch of about 2.5 millimeters.

17. The wrench of claim 10, wherein the worm gear is a double lead worm gear.

18. The wrench of claim 10, wherein the head includes a generally cylindrical aperture and wherein the rack gear is at least partially received within the cylindrical aperture and the rack gear slides within the cylindrical aperture to adjust the distance between the first jaw and the second jaw.

19. The wrench of claim 10, wherein the handle is an elongated handle having a front end portion and a rear end portion, wherein the head is coupled to the handle at the front end portion, and wherein an aperture extends through the handle at the rear end portion of the handle.
